(19) United States
(12) Patent Application Publication
(10) Pub. No.: US 2017/0318792 A9
(43) Pub. Date: Nov. 9, 2017

(54) LURE, ESPECIALLY FOR FISHING

(71) Applicant: Valtanen & Valtanen Oy, HELSINKI (FI)

(72) Inventor: Kari Valtanen, Helsinki (FI)

(73) Assignee: Valtanen & Valtanen Oy, HELSINKI (FI)

(21) Appl. No.: 15/014,284

(22) Filed: Feb. 3, 2016

(30) Foreign Application Priority Data
Feb. 10, 2015 (FI) 20155090

(51) Int. Cl. A01K 85/02; A01K 85/16; A01K 83/02

(52) U.S. Cl. CPC A01K 85/02; A01K 83/02; A01K 85/16

(57) ABSTRACT

The present invention relates to a lure (1), especially for fishing. An elongated body (5) includes attachment means (2) provided at a first end (51) of the body (5) for attaching the lure (1) to a fishing line or the like. a second end (52) of the body (5) is provided with a holder portion (5a) for keeping at least one hook (6a) stationary relative to the body (5). The lure (1) includes an elastic shell (4), which is provided with an installation chamber (4a) capable of accommodating the body (5) as well as the at least one hook (6a). The holder portion (5a) consists of a slot type hook saddle (5a). The shell (4) is provided with an aperture (4c) across which a tip portion of the hook (6a) is adapted to proceed from the installation chamber (4a) to a position external of the shell while the hook (6a) is stationary in the hook saddle (5a) at the same time as the shell (4) has its surface subjected to a pressure force compressing the shell (4). The hook (6a) is releasable from the hook saddle (5a) when the tip portion of the hook (6a) is located outside the shell (4).

The invention relates to a lure, especially for fishing, which comprises an elongated body, said body including attachment means provided at a first end of the body for attaching the lure to a fishing line or the like, a holder portion fashioned at a second end of the body for holding at least one hook stationary relative to the body, as well as an elastic shell provided with an installation chamber capable of accommodating the body as well as said at least one hook.

Casting is an internationally common form of fishing, wherein a lure is employed at the end of a fishing line (or possibly a leader attached at the tail end of a fishing line) for catching prey. The most typical types of lure include spoon, spinner and wobble lures. A problem with such lures is the working of a lure in the natural habitat of certain species of fish. For example, the natural habitat of pike, zander and perch is found in weedy or reedy shallow waters, as well as in rock formations. With ordinary casting lures, known as such for a person skilled in the art, the angling is highly challenging in such areas because the hooks of a lure are snagged in weeds or on rocks in shallow waters.

In order to eliminate this drawback there has been a development of lures with hooks concealed in the body or other structures of a lure. An example of such a lure is presented in Patent publication SE 90698. It discloses hooks, which are biased inside a body by means of a latch and spring provided on one half of the body and which are adapted to eject to a position external of the body as the halves of the body are pressed against each other. A similar assembly is presented in publication US 2004172874 A1. However, the assembly does not prevent a release of the hooks to a position external of the body even if the body is only pressed from the side provided with the latch. In order to be functional, this and similar assemblies also require a flexible body material, which is not a highly favorable material for use as a fishing lure. Similar types of lures, which are adapted to trigger as the lure is subjected to a force from one side, are also known from the following publications: US patent application 2007/0101634 A1, U.S. Pat. No. 4,176,489, U.S. Pat. No. 2,521,555, WO 2012/101314 A1.

A problem in all of the aforesaid prior art lures is the release of a bias with the individual hooks thereof and further the emergence of a hook outside the body and other structure before the lure is attacked by a prey, such as a fish. The use of such lures, at least in cast fishing, is problematic as the cocked conditions of hooks are easily released even as the lure is cast and it hits the water on the side that is subjected to a force intended for releasing the hooks. Thus, while under the surface of water, the lure encounters the same aforesaid problems as traditional lures. Likewise, when such a lure is sliding near the bottom in a body of water, the lure can be struck by numerous obstacles, such as rocks, weeds, tree trunks, with the result that the impact force generated on one side of the lure body triggers the bias of a hook or hooks. Hence, the hook or hooks proceed to a position external of the body, the lure thereby encountering also under the surface of water the same aforesaid problems as traditional lures.

It is an objective of the present invention to obviate the aforesaid drawbacks with a novel lure assembly, wherein the shifting of hooks to a position external of the body and other structure inadvertently or at a wrong time is completely eliminated.

The aforesaid objective of the invention is attained according to the invention in such a manner that said at least one hook is attached to the body by way of a first intermediate element, that the lure includes a holder portion made up of a slot type hook saddle; that the shell is provided with an aperture by way of which a tip portion of said at least one hook is adapted to proceed from the installation chamber to a position external of the shell as said at least one hook is stationary in the hook saddle while the shell has its surface subjected to a shell-compressing pressure force, and that while the tip portion of said at least one hook is outside the shell, the first intermediate element allows the release of said at least one hook from the hook saddle.

With the design of a lure 1 according to the invention there is provided a functionally novel type of lure, wherein the hook is certain not to leave the interior of a lure structure until the lure has already been snapped by a prey. In practice, this occurs as the fish receives the shell and body of a lure in its mouth, whereby the compressing/compressed shell enables a tip portion of the hook (hooks) to emerge while the latter are still supported in the hook saddle. The impact on water or the striking on underwater obstacles of a lure according to the invention, or a pull applied to the fishing line, cannot expose the hook (hooks) or the tips thereof. In addition, the novel type of structure for the holder portion enables the use of an elastic shell for the above-described purpose.

Preferred embodiments of the invention are presented in the appended dependent claims.

The invention will now be described more precisely with reference to the accompanying drawings, in which:

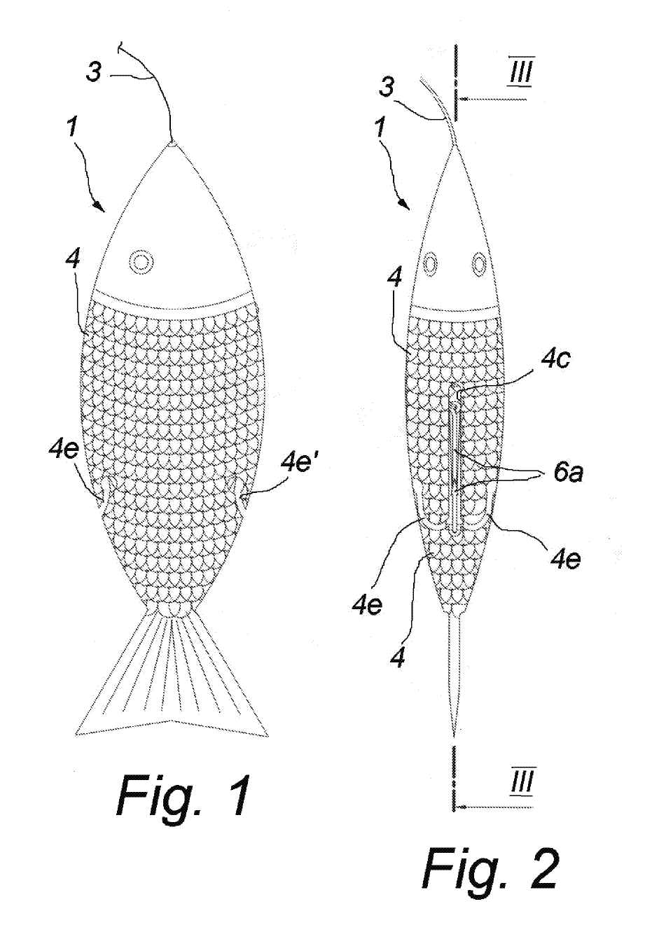

FIG. 1 shows a lure of the invention from a side,

FIG. 2 shows the lure of FIG. 1 from above,

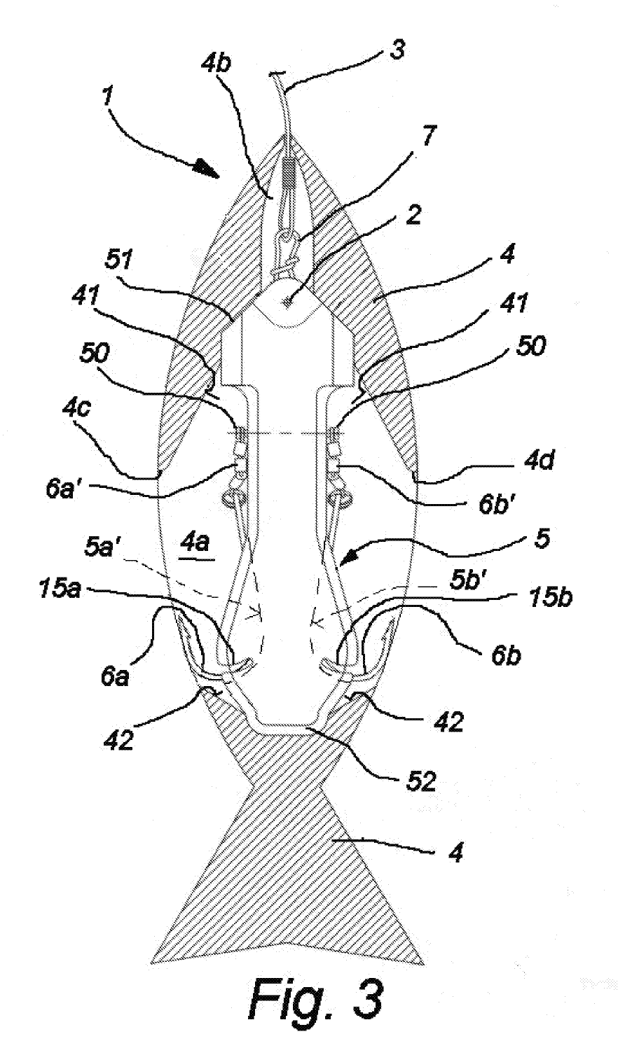

FIG. 3 shows a section along a section line in FIG. 2, showing a lure body of the invention from a side,

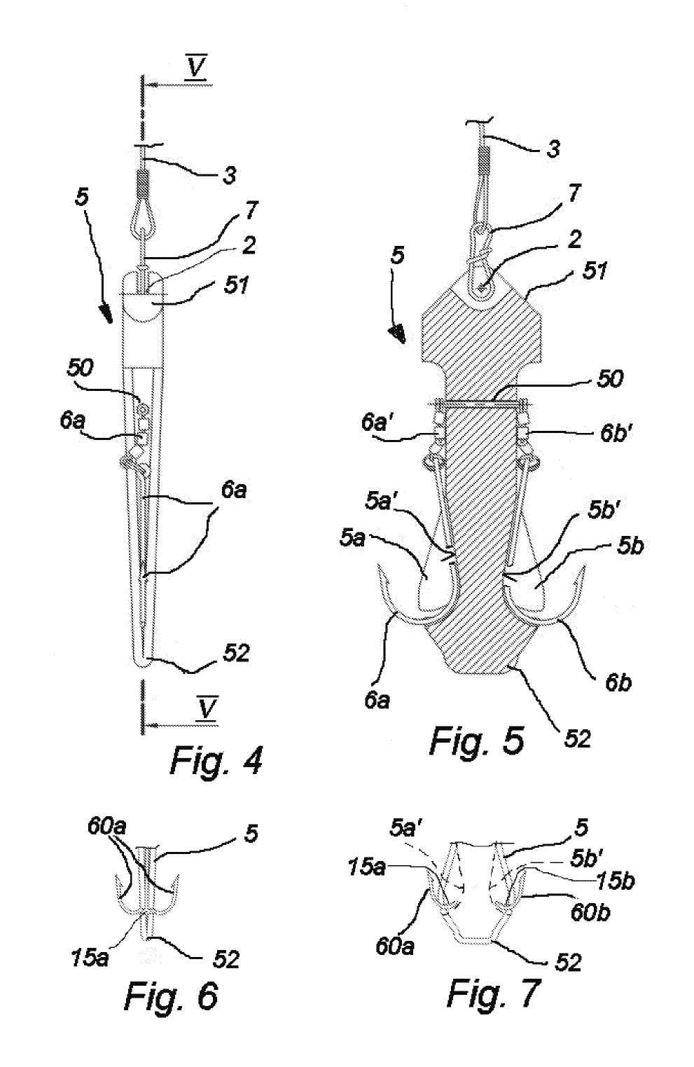

FIG. 4 shows the lure body from above,

FIG. 5 shows a section of the body along a section line V-V in FIG. 4,

FIG. 6 shows a partial overhead view of another preferred embodiment of the invention for a lure body, said body being provided with double hooks, and

FIG. 7 shows the body of FIG. 6 from a side.

Thus, what is presented in FIGS. 1 and 2 is a lure of the invention in a schematic plan view. The lure is denoted with reference numeral 1. The lure 1 includes s shell visible in FIGS. 1 and 2, which id denoted with reference numeral 4, as well as an elongated body 5 for the lure, which is shown in FIG. 3 and provided with at least one hook 6a. Subsequently, the term used in reference to the lure body 5 will be a body 3.

It can be seen from FIG. 3 that, in terms of its basic form, the shell 4 is a preferably fish-shaped elongated continuous object. Any form at all can be selected, yet preferably one to attract prey. The shell material consists of an elastic material. The shell material can also be a combination of several elastic materials. Examples of suitable elastic materials include rubber, plastics, silicone, and foam plastic. Other elastic materials can also be applied. In terms of its appearance, for example coloring and gloss, the shell 4 has preferably a surface which is attractive to prey. The surface can be treated for example by painting.

The shell 4 is provided with an installation chamber, which in FIG. 3 is denoted with reference numeral 4a. The shell is further provided with a plurality of apertures 4b, 4c, 4d, 4e, 4e′ whose function and purpose will be subsequently explained in more detail.

The installation chamber 4a is designed so as to enable the body 5 as well as said at least one hook 6a to be fitted therein. The body 5 is conductible into the installation chamber 4a and removable from the installation chamber 4a across an elongated aperture 4c. Therefore, the shell 4 can be replaced with a new or another type of shell as necessary. In the illustrated embodiment, the shell is provided with a similar type of another second aperture 4d, which is located on an opposite side of the shell 4 with regard to a longitudinal direction of the shell 4. Hence, the body 5 is also conductible into the installation chamber 4a across the second aperture 4d. Conduction of the body 5 according to the illustrated embodiment into the installation chamber 4a is rendered possible by elasticity of the shell as for example the size of apertures 4c and 4d adapts itself to the size of a body 5 to be conducted across the same.

The body 5 is preferably an elongated element, having its first end 51 provided with attachment means 2 for attaching the lure 1 to a fishing line 3 or the like. In this case, the attachment means 2 is a pin or the like, which is arranged in connection with the first end 51 and to which can be removably attached a leader 7 fixed to the end of the fishing line 3. The fishing line 3 can be attached to the stationarily installed body 5 by means of the leader 7 across a penetration cavity 4b constructed at the first end of the shell 4. A first end of the penetration cavity 4b opens to the exterior of the shell 4 and its second end opens into the installation chamber 4a. As a result, the leader 7 can be conducted by way of the first end into the penetration cavity 4b and further secured to the attachment means 2. Hence, the leader 7, and the attachment point between leader 7 and fishing line 3, will be located in the penetration cavity 4b safe from stresses of the surroundings. This also prevents the lure 1 from being snagged on obstacles by the leader 7. Furthermore, the rest of the fishing line 3 is conducted by way of the first end of the penetration cavity 4b to extend out of the shell 4.

The body 5 has its first end 51 and its second end 52 provided with formations which bear against respective internal surfaces 41 and 42 of the installation chamber 4a, thereby securing the shell 4 in a stationary position relative to the body 5. For the attachment, the user can stretch the elastic shell 4 in a longitudinal direction of the shell 4 for fitting the body 5 more easily in the installation chamber 4a as the installation chamber 4a and the apertures 4c and 4d increase in length. When stretching of the shell 4 is released, the shell 4 returns to its original shape and its internal surfaces 41 and 42 become pressed against the respective first end 51 and second end 52 of the body 5.

At the second end of the body 5, or in the proximity thereof, is provided a holder portion 5a by which said at least one hook 6a is retained stationary relative to the body 5 in the installation chamber 4a. The holder portion 5a is depicted more accurately in FIGS. 4 and 5. The invention can be implemented with a single holder portion 5a and a single hook 6a in engagement therewith. It is beneficial, however, that in connection with the body 5 be provided, on the opposite side relative to a longitudinal axis of the body 5, a second holder portion 5b for retaining a second hook 6b stationary as shown in the figures. What will be discussed in more detail hereinafter is the design and function of the holder portion 5a and the respective hook 6a and the corresponding reference numerals related to the second holder portion 6a are presented in parentheses.

The holder portion 5a (5b) consists of a slot type hook saddle, which is fashioned on the body and whose bottom 5a′ (5b′) is shaped in such a way that the hook 6a (6b) fitted therein bears against the bottom 5a′ (5b′). The hook saddle 5a (5b) has the width of its slot dimensioned in such a way that the hook 6a (6b) preferably wedges within the slot of the hook saddle 5a (5b), and further in such a way that the hook 6a (6b) disengages or can be disengaged from the holder portion 5a (5b) as a desired removal force is applied to the hook 6a (6b). Alternatively, the slot has its walls, which are an integral part of the body 5, shaped in such a way that the hook 6a (6b) attaches thereto in a formfitting manner, bearing against the bottom 5a′ (5b′). With the hook 6a (6b) stationary in the hook saddle 5a (5b), the hook 6a (6b) has its tip portion located preferably outside the body 5 in the proximity of the second end 52 of the body 5 regarding a longitudinal direction of the body 5. The hook has its second end also located outside the body 5, yet closer to the first end of the body 5 than the tip portion of the hook 6a (6b), preferably in a middle region of the body 5. Preferably at least 50%, more preferably 50-75%, of a total length of the hook 6a (6b) is located inside the holder portion 5a (5b) (the body 5). Thereby, the hooks are supported in the hook saddle 5a (5b) in such a way that the forces lateral to the depth direction of the slot, for example when a prey caught on the hook 6a (6b) is putting up a fight, are not able to substantially affect the hooks and thereby a distortion of the hook is prevented. This increases strength of the hook 6a (6b) in particular and further of the entire lure 1. In addition, this makes it possible that, in the lures 1 according to the invention, intended even for big preys, the thickness of a metal wire used in the hooks can be selected to be smaller than in prior art lures. Regardless of the lure size, the hooks 6a, 6b according to the invention are preferably manufactured from a thin wire made of stainless steel. Generally speaking, a hook made of thin wire is better in terms of catching prey. Depending on the intended use, the hooks can be naturally manufactured from heavier wire.

The body 5 is provided with a mounting axle 50 or other appropriate mounting object to which the hook 6a (6b) is connected by way of a respective intermediate element 6a′ (6b′). In a longitudinal direction of the body 5, the mounting axle 50 is located in the area between the second end of the hook 6a (6b) and the first end 51 of the body 5. The intermediate element 6a′ (6b′) is preferably an elongated chain or the like element made of a durable material such as steel. The chain 6a′ (6b′) has its first end attached pivotably to the mounting axle 50 and its second end fixed to the second end of the hook 6a (6b). The intermediate element 6a′ (6b′) keeps the hook 6a (6b) in connection with the body 5 as the hook 6a (6b) disengages from the holder portion 5a (5b). This design differs from the prior art constructions in the sense that the hooks 6a and 6b are not in a permanent attachment with the body 5 but, when disengaging from the hook saddles 5a′ and 5b′, they move freely relative to the body 5 while the intermediate element 6a′ (6b′) keeps them in connection with the body 5. Notable advantages of the intermediate element 6a′ (6b′) include a capability of replacing the hooks, for example with double hooks 60a (60b) shown in FIGS. 6 and 7. Moreover, being capable of moving freely, the thin wire hook withstands the stress applied thereto considerably better than hooks mounted rigidly to the body according to the prior art. The stresses applied to the hooks are principally generated by forces resulting from the movements of a prey caught on the hook. In prior art lures, the hooks in a fixed attachment with the body are subjected to a respective hook-bending moment, which is generated by said forces and which readily results in a distortion or even breakdown of the hook (loss of the prey). In comparison with the prior art, there will be a considerably lesser bending moment applied to hooks supported according to the invention by the intermediate elements 6a′ (6b′) for free movement.

As shown in FIG. 3, the aforesaid body 5 and the hooks 6a and 6b attached thereto are located in the installation chamber 4a of the elastic shell 4 according to the invention. When the lure 1 is cast into water for fishing, the forces applied thereto do not expose the tip portions of the hooks 6a and 6b. In other words, the shell does not compress in such a way that the tip portions of the hooks 6a and 6b would emerge across the apertures 4c and 4d to a position external of the installation chamber 4a. Neither do the underwater collisions with the bottom, vegetation or other obstacles enable an emergence of the hooks or the tip portions thereof from the installation chamber 4a. Neither does an external pull applied to the fishing line 3 have any influence whatsoever on the position of the hooks 6a and 6b relative to the body 5.

When the prey, such as a fish, snaps the lure 1 and thereby the shell 4 in its mouth in a manner known as such, the shell 4 shall have its surface subjected to a pressure force which compresses the shell 4. When the shell 4 is compressing at least from that side of the body 5 on which the hook 6a or 6b is located, the tip portion of at least this particular hook 6a, 6b departs from the installation chamber 4a to a position external of the shell 4. Hence, the discussed hook or hooks shall grab the prey and, depending on movements of the prey, the hooks 6a, 6b are caused to disengage from the hook saddle 5a, 5b.

With the lure 1 according to the invention, the grabbing of the hook 6a, 6b on a prey occurs practically at the same time as the shell 4 is subjected by the prey to a pressure force compressing the same. At the same time, the hooks 6a and 6b are also subjected by the prey to a force matching the pressure force. In view of this concept, the aforesaid design for the bottom 5a′ (5b′) of the saddle (holder portion) 5a (5b) is implemented in such a way that it conducts or at least enables a pivoting of the hook 6a (6b) in the hook saddle 5a (5b) as said pressure force compressing the shell 4 is applied to the hook 6a (6b). The hook 6a (6b) pivots in such a way that its tip portion points away from the body 5 while the hook 6a (6b) continues to be supported by the hook saddle 5a (5b). Such a pivoting of the hook 6a (6b) assists in catching a prey on the hook 6a (6b).

In addition to this, the intermediate element 6a′ (6b′) has its length selected in view of enabling the hook 6a (6b) to pivot in the saddle 5a (5b). In this case, the chain 6a′ (6b′) functioning as an intermediate element is in a slack condition between the second end of the hook 6a (6b) and the mounting axle 50, when the hook 6a (6b) is stationary as shown in FIG. 3. Hence, the chain 6a′ (6b′) does not impede or restrict a pivoting motion of the hook 6a (6b).

FIGS. 6 and 7 illustrate one preferred embodiment for the area of the second end 52 of the body 5, wherein the lure 1 is provided with double hooks 60a and 60b. Therefore, the holder portion 5a (5b) is provided with extra slots 15a (15b) for keeping the double hook 60a (60b) stationary relative to the body (5). In addition to this, the shell 4 is provided with matching extra apertures 4e (4e′) across which said double hook 60a (60b) is adapted to depart from the installation chamber 4a to a position external of the shell.

The invention is not limited solely to the presented embodiments, but can be applied in a multitude of ways within the scope of protection defined by the claims.

1. A lure (1), especially for fishing, which comprises an elongated body (5), said body (5) including attachment means (2) provided at a first end (5) of the body (5) for attaching the lure (1) to a fishing line or the like, a holder portion (5a) fashioned at a second end (52) of the body (5) for holding at least one hook (6a) stationary relative to the body (5), as well as an elastic shell (4) provided with an installation chamber (4a) capable of accommodating the body (5) as well as said at least one hook (6a), characterized in that said at least one hook (6a) is attached to the body (5) by way of a first intermediate element (6a′), that the lure (1) includes a holder portion (5a) made up of a slot type hook saddle (5a); that the shell (4) is provided with an aperture (4c) by way of which a tip portion of said at least one hook (6a) is adapted to proceed from the installation chamber (4a) to a position external of the shell as said at least one hook (6a) is stationary in. the hook saddle (5a) while the shell (4) has its surface subjected to a pressure force compressing the shell (4), and that while .the tip portion of said at least one hook (6a) is outside the shell (4), the first intermediate element (6a′) allows the release of said at least one hook (6a) from the hook saddle (5a).

2. A lure (1) according, to claim 1, characterized in that the holder portion (5a) consists of a slot type hook saddle (5a) whose bottom (5a′) comprises a formation that matches the shape of said at least one hook (6a), and which formation guides said at Least one hook (6a) to pivot in the hook saddle (5a) as said at least one hook (6a) is subjected to said pressure force compressing the shell (4).

3. A lure (1) according to claim 1, characterized in that said at least one hook (6a) is allowed by the first intermediate element (6a′) for a free movement relative to the body (5) while the intermediate element (6a′) keeps it in connection with the body (5).

4. A lure (1) according to claim 2, characterized in that the intermediate element (5a) is a chain whose first end is attached to a mounting axle (50) provided in the body, and whose second end is attached to the hook (6a), and that the chain (5a) is selected to have such a length that it enables a pivoting of said at least one hook (6a) in the saddle (5a) as said at least one hook (6a) is subjected to said pressure force compressing the shell (4).

5. A lure (1) according to claim 1, characterized in that the lure (1) is provided with a double hook (60a; 60b), that the holder portion (5a) is provided with extra slots (15a; 15b) for keeping, the double hook (60a; 60b) stationary relative to the body (5), and that the shell (4) is provided with an extra aperture (4e; 4e′) across which the tip portion of said double hook (60a; 60b) is adapted to depart from the installation chamber (4a) to a position external of the shell.

6. A lure (1) according to claim 1, characterized in that the body (5), on the opposite side of the body (5) with respect to the holder portion in terms of a longitudinal axis of the body (5), is provided with a second holder portion (5b) for keeping a second hook (6b; 60b) stationary relative to the body (5), that the shell (4) is provided with a second aperture (4d) across which the tip portion of said second hook (6b) is adapted to depart from the cavity chamber (4a) to a position external of the heft (4) as the shell (4) has its surface subjected to a pressure force compressing the shell (4).

7. A lure (1) according to claim 1, characterized in that the body (5) has its first end (51) and its second end (52) provided with formations which bear against an internal surface (41, 42) of the installation chamber (4a), thereby securing the shell (4) in place relative to the body (5).

8. A lure (1) according to claim 1, characterized in that the shell (4) is provided with a penetration cavity (4b) for passing out of the shell (4) a fishing line (3) or the like secured to the attachment means (2).

9. A lure (1) according to claim 8, characterized in that the fishing line (3) has its end provided with a leader (3a) capable of being passed across the penetration cavity (4b) to engagement with the attachment means (2) for securing the fishing line (3) to the lure (1), and that the leader (3a), which is fastened to the attachment means (2), is located in the penetration cavity (4b).

10. A lure (1) according to claim 1, characterized in that the hooks (6a, 6b; 60a, 60b) are manufactured from thin wire made of stainless steel.

11. A lure (1) according to claim 1, characterized in that the material for the shell (4) comprises rubber, plastics, silicone, foam plastic, or any combination thereof.
